(19) United States
(12) Patent Application Publication
(10) Pub. No.: US 2005/0060307 A1
(43) Pub. Date: Mar. 17, 2005

(54) System, method, and service for datatype caching, resolving, and escalating an SQL template with references

(75) Inventor: Liem Gioi Tran, San Jose, CA (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/662,087

(22) Filed: Sep. 12, 2003

(51) Int. Cl. G06F 7/00

(52) U.S. Cl. 707/4

(57) ABSTRACT

The datatype for a SQL template with references is cached, resolved, and escalated, accelerating the processing of the SQL template to fetch the datatype of the SQL template. The SQL template that the user provides for an object is also validated. The datatypes of the direct children of an SQL statement are required to resolve the datatype of the SQL template. Consequently, the datatype of each object with its associated SQL template is placed in cache to leverage its use when referenced by another object. An advantage is that datatype resolution may be performed in constant time since the SQL template remains the same except for the substitution of datatypes for tokens. In addition, the algorithm generating the valid SQL statement used to resolve the datatype is relatively simple, using a simple “search and replace” of tokens with the function “cast(NULL as DATATYPE)”. Furthermore, the resulting valid SQL statement is much smaller than that provided by conventional systems. Consequently, the depth of the reference tree analyzed for datatype may be much larger than that analyzed by conventional systems and methods.

### FIELD OF THE INVENTION

The present invention generally relates to datatypes of SQL templates with references. More specifically, this invention relates to a method for resolving and storing datatypes for SQL expressions so that users may query a database or SQL processor to determine the validity of an SQL expression and quickly obtain the datatype of the SQL expression.

### BACKGROUND OF THE INVENTION

Data records in a relational database management system (RDBMS) in a computer are maintained in tables, which are a collection of rows all having the same columns. Each column maintains information on a particular type of data for the data records that comprise the rows. Database tables may be accessed using the Structured Query Language (SQL) commands, which comprises a recognized language to query, access, and manipulate data in a database. The SQL language comprises set operators that define operations to be performed when searching columns of database tables. For instance, a SQL set operator may look for all records having a field that satisfies a certain search condition, such as equal to, less than, etc. to a certain value.

Due to OLAP popularity, relational databases have been extended to support OLAP. Associated with OLAP is its metadata. Associated with the metadata are logical objects such as cube, cube models, and ultimately attributes and measures. These attribute & measure objects comprise an SQL template and a list of reference objects.

These object references are qualified by the schema name and object name, ultimately referencing columns within a database. Any object, such as an attribute or measure has associated with it an SQL template comprised of an expression involving another object such as an attribute, measure, or column.

A complicated object may be more than just a column in a table. Each object has associated with it an SQL expression describing the object. The object can be built on top of other existing object(s). Thus, the associated SQL template can build on top of other existing templates, creating a tree of SQL templates. This tree can be very deep, comprising many SQL templates.

Associated with the object is the datatype. This datatype needs to be returned for user consumption. This datatype is ultimately the complex SQL template that comprises object references to other attributes or measures. An SQL template might be, for example:
A=$$1+$$2*$$3,
where $$1, $$2, $$3 are object references or tokens that reference other SQL templates or objects. To determine the datatype of A, the OLAP implementer needs to determine the datatype of each of the components of A. Each of the references of A might, in turn, be complex SQL templates depending on additional SQL templates, requiring extensive, time-consuming processing to identify the datatype of A. To resolve the datatype of A, the SQL processor may have to take the SQL template all the way to the bottom of the tree and compose a big and complex SQL expression to determine the datatype of the original object e.g., A.

A conventional method to determine the datatype by the OLAP implementer for an SQL template is to start with the original template and start substituting its references for the reference's SQL template if the reference is an attribute or measure object. This substitution process is recursively applied for all the descendants until the SQL template comprises only references to columns in the relational database.

The tree for the SQL template (or objects) can be very deep. Since the OLAP implementer fetches all of the templates for all of the descendents of a SQL template, extensive processing may be required to resolve the SQL template into an expression containing columns.

This conventional approach for determining the datatype for an SQL template can be very expensive in terms of processing resources. If the depth of the tree is long, then the time required to resolve the SQL template into columns is proportional to N², where N is the depth of the tree. In addition, the resolved SQL expression that comprises only columns may be very complicated and long. Many RDBMSs limit the length of an SQL statement.

Consequently, the maximum length of the resolved SQL statement may limit the depth of the reference tree for the SQL statement for which a datatype may be resolved. This then limits the depth of the tree for object references and thus limits the reusability of an existing attribute or measure for another attribute or measure. Furthermore, the programming code required to create a valid SQL statement to resolve the datatype may be very complicated because this code comprises parsing out the table name and schema name to create the FROM clause. In addition, there may be duplicates of columns and tables within the resolved SQL expression making the FROM clause of the SQL statement unnecessarily long.

What is therefore needed is a system, a service, a computer program product, and an associated method for determining the datatype of an SQL expression without extensive and time consuming processing by an SQL processor. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for datatype caching, resolving, and escalating an SQL expression with references. The present system accelerates the processing of the SQL expression to fetch the datatype of the SQL expression. Concurrently, the present system validates the SQL expression that the user provides for the object for which the datatype is requested.

The datatypes of the direct children of an SQL statement are required to resolve the datatype of the SQL statement. Consequently, the present system places in cache the datatype of each object to leverage its use when referenced by another object. An advantage of the present system is that datatype resolution may be performed in constant time (much faster than the conventional solution) since the SQL expression remains the same except for the substitution of datatypes for tokens. As used herein, constant time means that regardless of how deep the nesting of the SQL templates or objects is, the time required to process the SQL template is the same because only the datatype one level down is fetched, as opposed to fetching many levels down depending on the depth of the tree.

In addition, the algorithm of the present system for generating the valid SQL statement used to resolve the datatype is relatively simple, using a simple “search and replace” of tokens with the function “CAST(NULL as DATATYPE)”. Furthermore, the resulting valid SQL statement is much smaller than that provided by conventional systems. Consequently, the depth of the reference tree analyzed for datatype may be much larger.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a datatype caching, resolving, and escalating system for SQL expressions of the present invention can be used;

FIG. 2 is a block diagram of the high-level architecture of the datatype caching, resolving, and escalating system of FIG. 1;

FIG. 3 is a diagram of an exemplary tree of SQL expressions illustrating the operation of the datatype caching, resolving, and escalating system of FIGS. 1 and 2;

FIG. 4 is a diagram of an exemplary tree of SQL expressions with tokens replaced by columns illustrating the operation of the datatype caching, resolving, and escalating system of FIGS. 1 and 2; and

FIG. 5 is comprised of FIGS. 5A, 5B, and 5C and is a process flow chart illustrating a method of operation of the distributed datatype caching, resolving, and escalating system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Ancestor: A node (as in a graph or tree) with a successor, or the immediate predecessor of a node in a tree.

Depth (level) of a node: The number of nodes from the root to the node in its tree.

Descendent: From graph theory, a node pointed to by a path from an ancestor.

Internet: A collection of interconnected public and private computer networks that are linked together with routers by a set of standard protocols to form a global, distributed network.

Leaf: Terminal node of a tree, a node with no child.

Node: A point or vertex in a graph or tree.

SQL: Structured Query Language, a standardized query language for requesting information from a database.

Tree: A hierarchical structure that is made up by nodes. Nodes are connected by edges from one node (ancestor) to another (descendent). A single node at the apex of the tree is known as the root node, while the terminus of a path is a leaf.

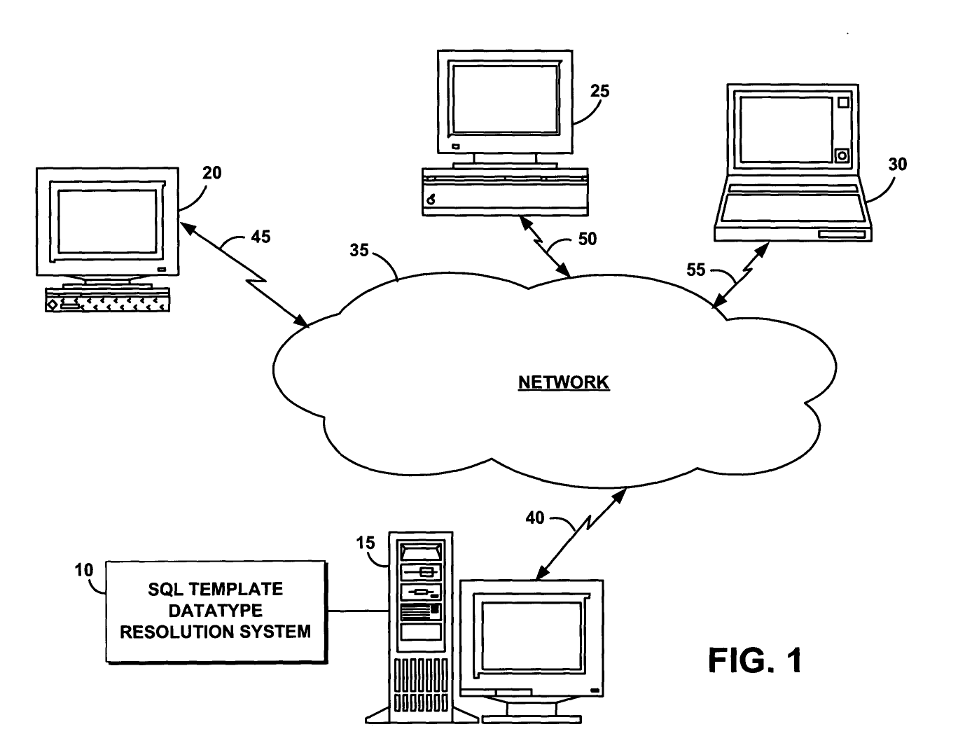

FIG. 1 portrays an exemplary overall environment in which a system, service, and associated method for datatype caching, resolving, and escalating an SQL expression with references according to the present invention may be used. System 10 comprises a software programming code or a computer program product that is typically embedded within, or installed on a host server 15. Alternatively, system 10 can be saved on a suitable storage medium such as a diskette, a CD, a hard drive, or like devices.

Users, such as remote Internet users, are represented by a variety of computers such as computers 20, 25, 30, and can query the host server 15 for desired information through a network 35. Computers 20, 25, 30 each comprise software that allows the user to interface securely with the host server 15. The host server 15 is connected to network 35 via a communications link 40 such as a telephone, cable, or satellite link. Computers 20, 25, 30 can be connected to network 35 via communications links 45, 50, 55, respectively. While system 10 is described in terms of network 35, computers 20, 25, 30 may also access system 10 locally rather than remotely. Computers 20, 25, 30 may access system 10 either manually, or automatically through the use of an application.

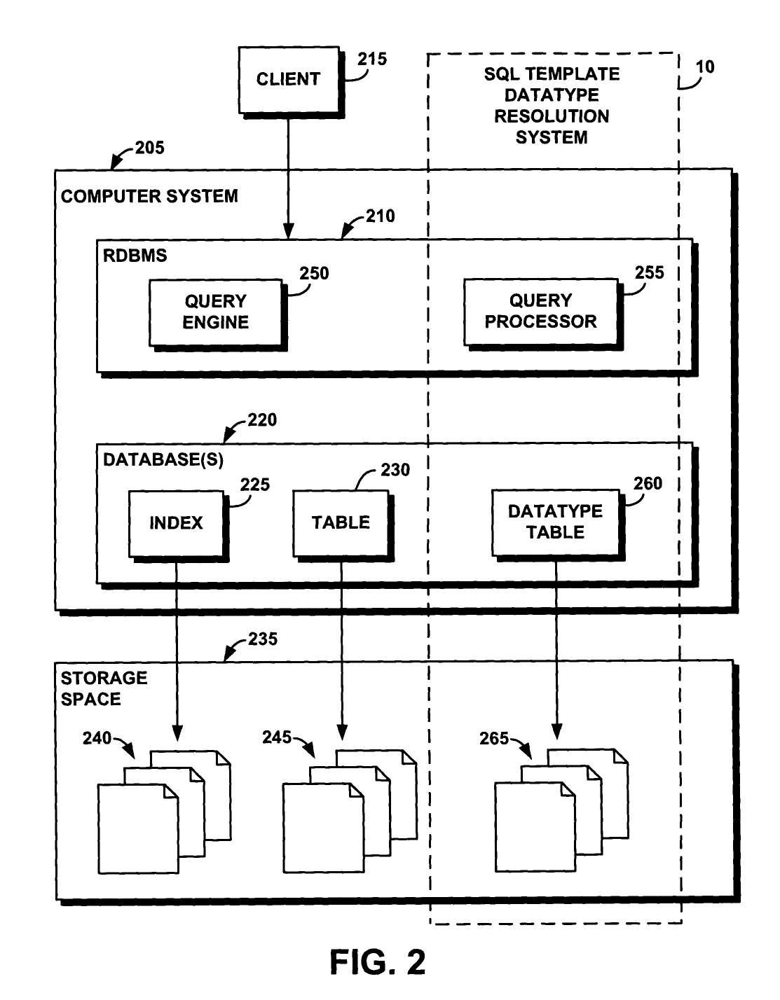

FIG. 2 illustrates a computing environment in which a database utilizing system 10 may be implemented. While system 10 is described in relation to a database for exemplary purposes, system 10 may be used with any SQL query engine, processor, etc. A computer system 205 comprises a relational database management system 210 (also referenced herein as RDBMS 210), such as DB2®, MICROSOFT Access®, Oracle Corporation's ORACLE 8®, etc. A client 215 accesses RDBMS 210 to access database information maintained in one or more databases 220. Client 215 may be either an individual user or an application, and access RDBMS 210 either manually or automatically. Client 215 also accesses RDBMS 210 to determine the datatype of an SQL expression for objects stored in RDBMS 210. Database(s) 220 may comprise one or more indexes 225 and one or more tables 230 (also referenced herein, such as relational tables 230). Indexes 225 provide an ordered set of pointers to data in table 230 based on the data in one or more columns of table 230.

A storage space 235 stores the actual data sets that comprise the data for indexes 225 and tables 230. The storage space 235 comprises one or more pages 240 that contain the index entries for index 225, such as the leaf pages when index 225 is comprised of a B-tree. The storage space 235 further comprises one or more pages 245 of the records in table 230. The storage space 235 may comprise a non-volatile storage space, such as a direct access storage device (DASD), which is comprised of numerous interconnected hard disk drives. Alternatively, the storage space 235 may comprise storage pools within non-volatile memory, or a combination of non-volatile and volatile memories.

RDBMS 210 comprises a query engine 250 that may receive a search request on attributes in dimension tables to locate records in a fact table. In such case, the query engine 250 may join the multiple tables 230, using optimization techniques known in the art, to optimally determine the order of joining the tables 230 for purposes of searching for matching values.

System 10 is comprised of a query processor 255, a datatype table 260, and one or more datatype pages 265. Client 215 may submit SQL templates with references to the query processor 255 for validation or to obtain the datatype of an SQL expression. Datatypes for SQL templates are stored in the datatype pages 265 and referenced by the datatype table 260.

In one exemplary embodiment, databases such as RDBMS 210 are based on a relational model. According to the relational model, data is perceived to exist as a collection of tables such as relationship table 230. The relational table 230 expresses a relation between things. The relational tables 230 are characterized by rows and columns. Although the rows and columns of the relational tables 230 may be employed in many ways, the relational model provides that columns pertain to entities or attributes of entities, and that rows pertain to specific instances of entities or specific instances of attributes of an entity. In addition, the rows and columns of the relational tables 230 intersect to define data cells.

The function calls that an application program may make to RDBMS 210 have a somewhat standardized structure that is tailored to the relational model. This structure for function calls to RDBMS 210 is generally referenced as the Structured Query Language (SQL).

Each column of the relational table 230 has a respective datatype. The datatype of a column restricts the values for the cells of a column. For example, a traditional datatype for a column of the relational table 230 is the integer datatype. If a column has the integer datatype, the cells of that column may have only integer values. Other traditional datatypes comprise packed decimal, floating point, fixed length character, and variable length character datatypes. Non-traditional datatypes comprise images, videos, fingerprints, large objects, and audio.

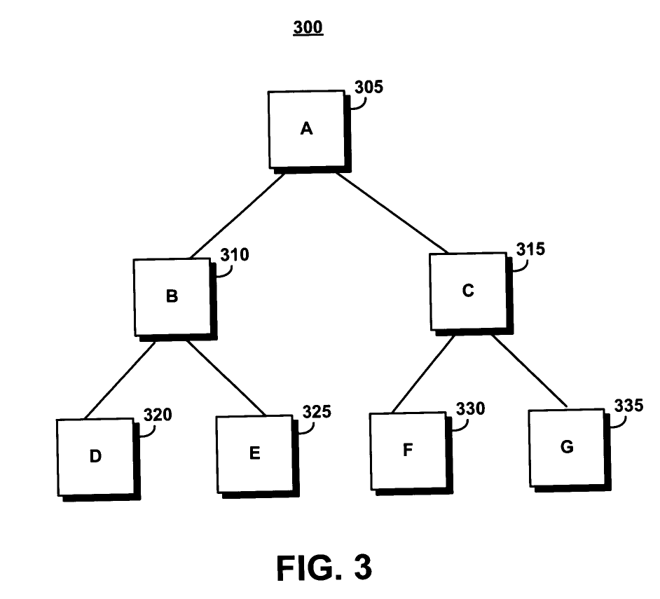

SQL statements may be comprised of functions of other SQL statements. Such an SQL statement may be expressed as a tree. An exemplary SQL tree 300 is illustrated by the diagram of FIG. 3. Each node in the SQL tree 300 is represented by a letter such as A 305, B 310, C 315, D 320, E 325, F 330, and G 335, where each letter represents a SQL template by itself. Letters A 305, B 310, C 315, D 320, E 325, F 330, and G 335 reference each other through a “token” in the SQL template. For example, the expression for A 305 might be:
A 305=$$1+$$2,
where “$$#” represents the token. In this example, $$1 represents B 310 and $$2 represents C 315. Each numeric value represents a different token, a different reference. Each token can be another template. For example, B 310 might be as follows:
B 310=$$B1*$$B2,
where $$B1 is D 320 and $$B2 is E 325. The template for C 315 might be as follows:
C 315=$$C1/$$C2,
where $$C1 is F 330 and $$C2 is G 335.

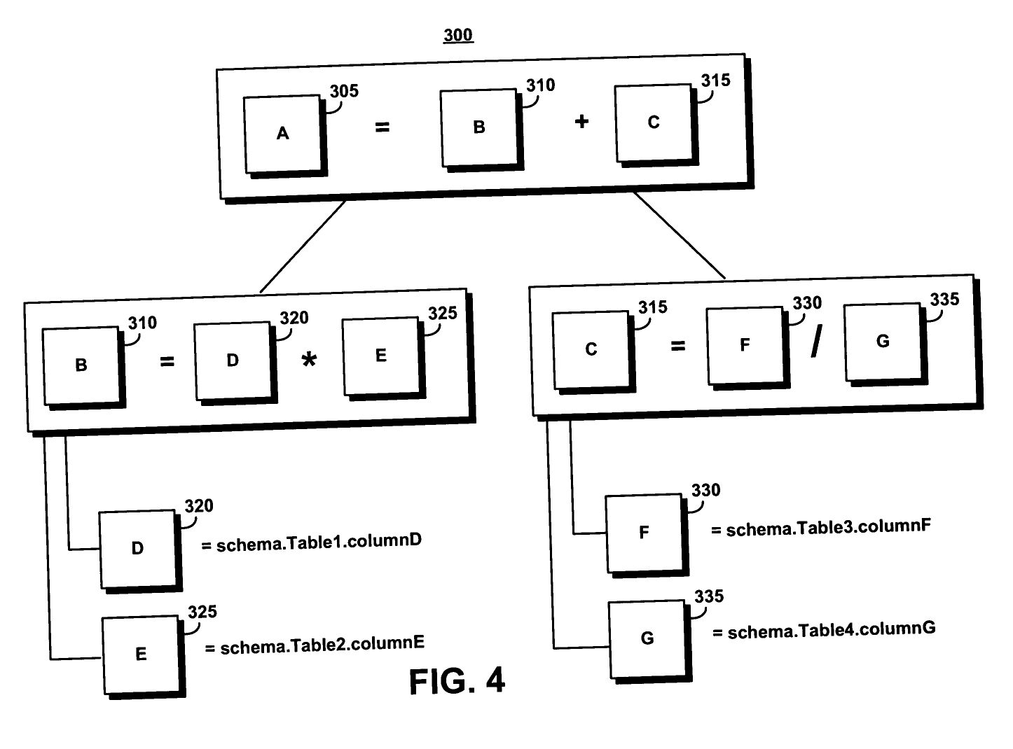

In addition, with reference to FIG. 4, each token may represent a column. The nodes (or leaves) at the bottom of the tree represent columns. In the example of the SQL tree 300, D 320, E 325, F 330, and G 335 all reference columns such as:
D 320=Schema.Table1.ColumnD (datatype=integer)
E 325=Schema.Table2.ColumnE (datatype=integer)
F 330=Schema.Table3.ColumnF (datatype=double)
G 335=Schema.Table4.ColumnG (datatype=double)

By replacing each token in the templates for the nodes in the SQL tree 300, eventually any node in the SQL tree 300 may be expressed only in columns. For example,
A 305=$$1+$$2=B 310+C 315.
Substituting values for B 310 and C 315 yields:
A 305=($$B1*$$B2)+($$C1/$$C2)=(column D 320 * column E 325)+(column F 330/column G 335)
shown in graphical form in FIG. 4.

Each column has associated with it a datatype. Client 215 queries RDBMS 210 to determine the datatype of an SQL template and/or validate the SQL template. To quickly provide the datatype of the SQL template and validate the SQL template, system 10 predetermines the datatype for each SQL template and stores that datatype in the datatype table 260. The datatype table 260 comprises five columns, three of which are used to save the datatype for each object: typename, typeschema, and typelength. The other two columns are used to store the object's unique identifier comprised of the object's name and schema.

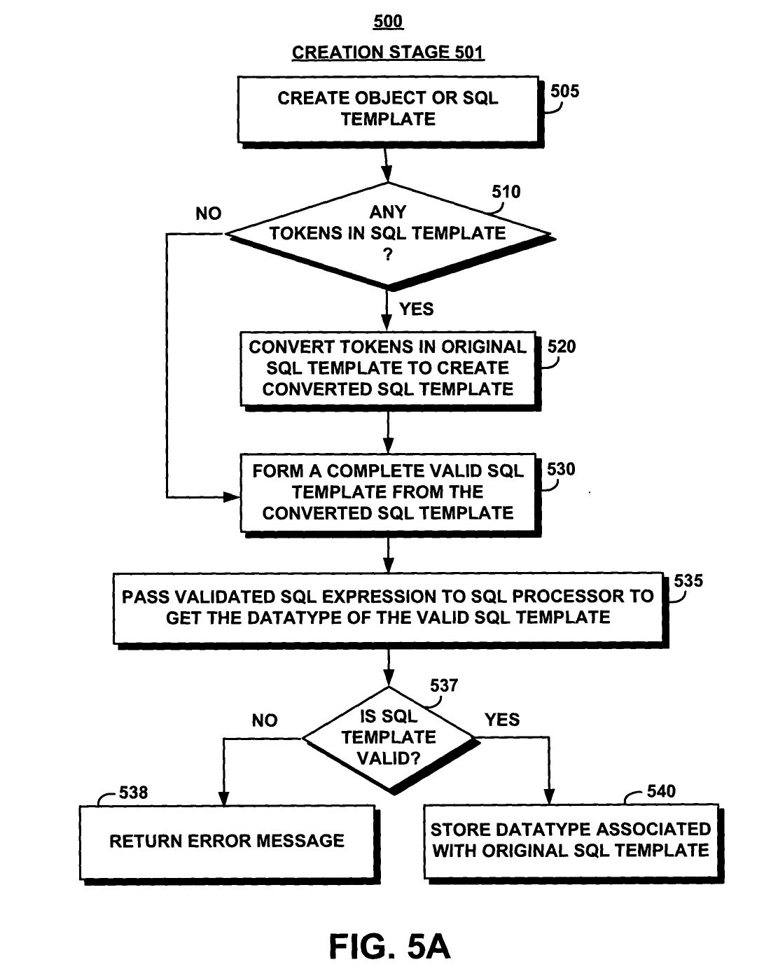

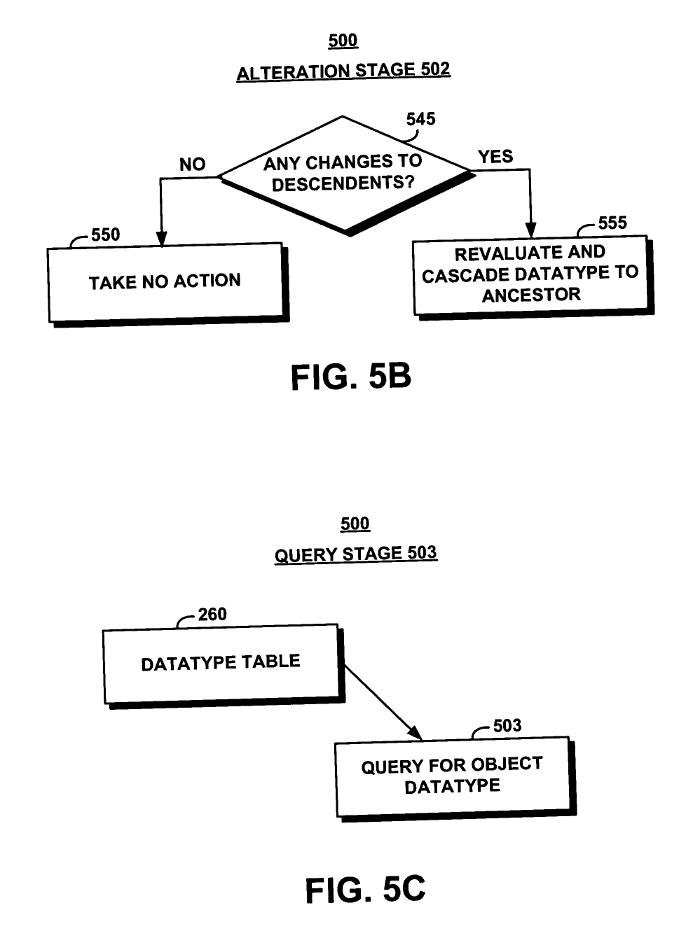

A method 500 of operation of system 10 is illustrated by the process flow chart of FIG. 5 (FIGS. 5A, 5B, and 5C). In general, method 500 is comprised of three stages. The first stage 501 is the creation stage, and is illustrated by FIG. 5A. The second stage 502 is the alteration stage, and is illustrated by FIG. 5B. The third stage 503 (FIG. 5C) is the query stage, wherein system 10 queries for the object's datatype, which stage can be implemented by fetching the datatype directly from the datatype table 260.

Referring now to FIG. 5A, system 10 receives a node for SQL template validation & datatype caching at block 505 based on existing nodes/templates. If the SQL template at the selected node contains no tokens at decision block 510, the SQL template for the node is not converted and passed on to block 530. For each token within an SQL expression that contains tokens, system 10 forms the converted SQL statement by obtaining the datatype of the reference and replaces the corresponding token with a function such as, for example, a cast(NULL as datatype) function at block 520. The cast(NULL . . . ) function is a known database specification or function. The CAST function returns the cast operand (i.e., the first operand) cast to the type specified by the data type. For the example of FIG. 3, the cast function is inserted in place of each token:
C 315=$$1/$$2=cast(NULL as double)/cast(NULL as double)
B 310=$$1*$$2=cast(NULL as int)*cast(NULL as int)
A 305=$$1+$$2=cast(NULL as int)+cast(NULL as double).

System 10 then forms a complete valid SQL expression from the converted SQL expressions at block 530. To form the complete valid SQL expression from the converted SQL expressions, system 10 inserts a SELECT clause in front of the modified SQL expression. For example, the expression for A 305 becomes:
A 305=SELECT cast(NULL as int)+cast(NULL as double).
System 10 selects FROM any dummy table that always exists:
FROM syscat.schemata
   System 10 then merges these two clauses to obtain the following for A 305:
SELECT cast(NULL as int)+cast(NULL as double)
FROM syscat.schemata

A dummy table can be any existing table. In this example, syscat.schemata is used. System 10 passes the converted SQL expression to the query processor 255 to validate the SQL expression & get the datatype of the valid expression at block 535 via a describe operation.

At decision block 537, a decision is made on whether or not the SQL template is valid. Process 500 continues if the SQL template is valid. If the SQL template is not valid, method 500 proceeds to block 538 where it returns an error message to the user. Otherwise, if the SQL template is determined to be valid, system 10 stores the datatype associated with the original SQL template in datatype table 260, at block 540. An exemplary datatype table 260 is shown in Table 1 below.

TABLE 1
An exemplary datatype table created by system 10 for a database
such as, for example, DB2 ®.

| colname | colTypeSchema | colTypeName | colTypeLength | colTypeScale |
|---|---|---|---|---|
| TYPESCHEMA | SYSIBM | VARCHAR | 128 | 0 |
| TYPENAME | SYSIBM | VARCHAR | 128 | 0 |
| TYPELENGTH | SYSIBM | INTEGER | 4 | 0 |
| TYPESCALE | SYSIBM | SMALLINT | 2 | 0 |
| SQLTEMPLATE | SYSIBM | VARCHAR | 254 | 0 |

Turning to FIG. 5B, system 10 monitors the reference tree of SQL expressions at decision block 545. If no change is made to the descendents within the reference tree, system 10 takes no action at block 550. If the datatype of any referenced object within an existing reference tree is modified, the modification is escalated or cascaded to the ancestors of the modified SQL expression or object (block 555).

System 10 assumes that the SQL expression comprises tokens for the columns referenced rather than the actual columns. For example, system 10 operates on
SQL template=$$1+$$2, where $$1=column A & $$2=column B in a list of references, rather than
SQL template=Table1. column_A+Table2.column_B with a list of references that is empty.

Any columns identified within the template by system 10 are parsed out to get the additional tables. System 10 then appends these tables to the FROM clause in block 530. This is needed, otherwise the FROM clause would be empty and this would not be a valid and complete SQL statement.

Turning to FIG. 5C, the third stage 503 (FIG. 5C) is the query stage, wherein system 10 queries for the object's datatype, which stage can be implemented by fetching the datatype directly from the datatype table 260.

It is to be understood that the specific embodiments of the invention that have been described are merely illustrative of certain applications of the principle of the present invention. Numerous modifications may be made to datatype caching, resolving, and escalating an SQL template with references as described herein without departing from the spirit and scope of the present invention.

1. A method for datatype caching of an SQL template with references, comprising:
converting the SQL template into a converted SQL template with an associated cast function;
acquiring a datatype of the converted SQL template; and
storing the datatype of the converted SQL template with the SQL template.

2. The method of claim 1, wherein converting the SQL template comprises replacing tokens in the SQL template with the associated cast function.

3. The method of claim 2, further comprising forming a valid SQL statement from the converted SQL template.

4. The method of claim 3, wherein forming the valid SQL template comprises acquiring the datatype of the valid SQL statement.

5. The method of claim 4, wherein acquiring the datatype of the converted SQL statement comprises passing the valid SQL statement through an SQL processor.

6. The method of claim 1, further comprising inquiring if a descendent of the converted SQL template has been modified.

7. The method of claim 6, wherein if the descendent of the converted SQL template has been modified, re-evaluating an SQL template for the descendent and cascading a modified datatype up to ancestors of the converted SQL template.

8. A computer program product having instruction codes for datatype caching of an SQL template with references, comprising:
a first set of instruction codes for converting the SQL template into a converted SQL template with an associated cast function;
a second set of instruction codes for acquiring a datatype of the converted SQL template; and
a third set of instruction codes for storing the datatype of the converted SQL template with the SQL template.

9. The computer program product of claim 8, wherein the of instruction codes replaces tokens in the SQL template with the associated cast function.

10. The computer program product of claim 9, further comprising a fourth set of instruction codes for forming a valid SQL statement from the converted SQL template.

11. The computer program product of claim 10, wherein the fourth set of instruction codes acquires the datatype of the valid SQL statement.

12. The computer program product of claim 11, wherein the fourth set of instruction codes passes the valid SQL statement through an SQL processor.

13. The computer program product of claim 8, further comprising a fifth set of instruction codes for inquiring if a descendent of the converted SQL template has been modified.

14. The computer program product of claim 13, wherein if the descendent of the converted SQL template has been modified, the fifth set of instruction codes re-evaluates an SQL template for the descendent and cascades a modified datatype up to ancestors of the converted SQL template.

15. A system for datatype caching of an SQL template with references, comprising:
means for converting the SQL template into a converted SQL template with an associated cast function;
means for acquiring a datatype of the converted SQL template; and
means for storing the datatype of the converted SQL template with the SQL template.

16. The system of claim 15, wherein the means for converting the SQL template comprises means for replacing tokens in the SQL template with the associated cast function.

17. The system of claim 16, further comprising means for forming a valid SQL statement from the converted SQL template.

18. The system of claim 17, wherein the means for forming the valid SQL template comprises means for acquiring the datatype of the valid SQL statement.

19. The system of claim 18, wherein the means for acquiring the datatype of the converted SQL statement comprises means for passing the valid SQL statement through an SQL processor.

20. The system of claim 15, further comprising means for inquiring if a descendent of the converted SQL template has been modified; and
further comprising means for re-evaluating an SQL template for the descendent and for cascading a modified datatype up to ancestors of the converted SQL template if the descendent of the converted SQL template has been modified.
